(19) United States
(12) Patent Application Publication
(10) Pub. No.: US 2020/0330199 A1
(43) Pub. Date: Oct. 22, 2020

(54) DENTAL DIVESTMENT METHOD AND MUFFLE

(71) Applicant: Ivoclar Vivadent AG, Schaan (LI)

(72) Inventors: Aleksandar Tubic, Wien (AT); Manual Schlegal, Mels (CH); Rudlf Jussel, Feldkirch-Gisingen (AT)

(21) Appl. No.: 16/848,986

(22) Filed: Apr. 15, 2020

(30) Foreign Application Priority Data
Apr. 18, 2019 (EP) 19170112.7

(51) Int. Cl. A61C 13/20; A61C 13/00; A61C 13/08

(52) U.S. Cl. CPC A61C 13/206; A61C 13/081; A61C 13/0007; A61C 13/0019

(57) ABSTRACT

The invention relates to a dental divestment method in which dental restoration parts are divested from a cured muffle by sandblasting. In the production of the muffle molded part or moldings (20) or protrusions (58) are realized in or at the casting mold by means of a casting compound (21), said molded part or moldings or protrusions consisting of a burn-out material. They are removed after curing. The indentations produced in this way are configured as predetermined breaking points for the muffle.

### CROSS-REFERENCE TO RELATED APPLICATIONS

This application claims priority to European patent application No. 19170112.7 filed on Apr. 18, 2019, the disclosure of which is incorporated herein by reference in its entirety.

### FIELD OF INVENTION

The invention relates to a dental divestment method and to a dental muffle.

### BACKGROUND

Muffles are used for the production of in particular ceramic dental restoration parts to a very large extent. They consist of a casting compound, e.g. gypsum, and are removed from the furnace after completion of the press process and the firing cycle in the press furnace, also known as a muffle furnace.

In this state, the muffle is still relatively hot, e.g. 900° C., and it comes down to divesting the dental restoration part or the plurality of dental restoration parts invested in the muffle.

Typically, the muffle is initially cooled increasingly for this purpose until it can be machined. Then, machining takes place by means of abrasive cutters or also by means of sandblasting, wherein particularly in cases of large muffles of e.g. 300 g, a considerable consumption of tools or also of sand occurs.

Additionally, it takes especially large muffles quite long to cool down to a processing temperature.

Attempts have been made to machine the muffles already in a relatively hot state by means of abrasive cutters which are particularly temperature-resistant.

However, on the one hand, tools of this kind are considerably more expensive, and on the other hand, wear is significantly higher. Altogether, a significant degree of manual and time-intensive processing is required up to now for successful divestment.

To reduce at least the manual processing, it has been suggested already to carry out the sandblasting process in a closed housing and to automate it to a certain extent.

However, purchase of a sandblasting device of this type is comparatively expensive, it is unifunctional and requires regular cleaning. In addition, consumption of the relatively expensive sandblasting material is higher here compared with manual sandblasting.

In this respect, it is not surprising that closed solutions of this type have not prevailed.

On the other hand, it is important that the glass ceramic or the other dental restoration part is not damaged in the divestment process.

For this purpose, it has become known to carry out an initial pre-blasting process using rough sand and to then carry out post-blasting using fine sand. Here, too, the operator must maintain a safety distance to the dental restoration part by way of precaution.

It is not guaranteed in all cases that the operator knows where exactly the dental restoration parts are positioned within the muffle as they are not visible.

U.S. Pat. No. 6,013,125, 20180194039, 20090155736, 20120121752 and 20170007380 are directed to muffles and methods of using muffles and are hereby incorporated by reference in their entirety.

### SUMMARY

The invention is based on the task of providing a dental divestment method according to the claims and a dental muffle according to the claims, which is improved considerably with regard to the process time and efficiency and also with regard to the costs.

It is provided according to the invention that the muffle which is typically purely cylindrical on the lateral surface is discontinuous at least on its outer or lateral surface. For this purpose, molded parts or moldings or protrusions which discontinue the lateral surface are realized at the casting mold for the muffle which is also preferably cylindrical. The molded parts or moldings or protrusions are supported on the casting mold and are fabricated of a removable material, such as wax, in a first embodiment.

In a second embodiment, molded parts or moldings and protrusions are fabricated of a heat-resistant or non-removable (non burn-out) material, which differs from the material of the casting compound. Particularly suitable is a molded part or molding material which is dispersed in comparison to the material of the casting compound. The material of the molded part may be, for example, steel or another metal or ceramics such as ZrO₂ or Al₂O₃.

The material is to have a smooth surface. The surface roughness Rₐ amounts to less than 5 μm and in particular to less than 1 μm.

A method for producing dental articles is provided, which includes shaping a model of a desired dental article using a removable material, inserting the model into a muffle, inserting one or more molded parts or protrusions fabricated of a removable material in the muffle above and/or below the model, inserting casting material into the muffle and curing the casting material, removing the removable material, wherein molds for the desired dental article are produced from the model, wherein indentations or cavities are produced from the one or more molded parts or protrusions, wherein the indentations or mold cavities produced are configured and/or used as one or more predetermined breaking points for the muffle during divestment.

A method for producing dental articles is provided, which includes shaping a model of a desired dental article using a removable material, inserting the model into a muffle, inserting one or more molded parts or protrusions fabricated of a heat-resistant material which does not burn out during the burn-out process, in the muffle above and/or below the model, inserting casting material into the muffle and curing the casting material, removing the removable material, wherein molds for the desired dental article are produced from the model, wherein the one or more molded parts or protrusions remain and are configured and/or used as one or more predetermined breaking points for the muffle during divestment.

The processing herein takes place as part of a press process which is slightly modified compared to the press process known per se and which is explained herein and additionally with regard to the invention.

Initially, a dental restoration part is molded from a material which may be burnt out, such as wax, either using an analogous process or e.g. using digital aids.

Alternatively, several dental restoration parts may also be produced having the desired shape. Each of these parts is connected to a shared base using a channel referred to as sprue channel which is a short wax rod, in such a way that the parts maintain a certain minimum distance of, such as by not limited to a range of about 5 mm to about 1 cm from each other.

The wax base is then placed on a muffle mandrel having a muffle base, and a molded part or molded part or molding is mounted on the muffle base or to the muffle mandrel, which extends outwards to the muffle shell surface. The molded part or molding has apertures or openings and extends below the dental restoration parts in any case.

The muffle ring is then placed onto the investment ring or muffle base and sealed against the base of the investment ring or against the muffle bottom at the bottom. In a preferred realization of the invention the muffle lid also comprises a molded part or molding which terminates just above the dental restorations and which is also permeable to investment material.

An investment material, such as but not limited to gypsum, cristobalite, and silica, is inserted via a filling opening in the muffle lid such that the interior of the muffle ring is filled with investment material completely.

When the muffle lid does not have a filling opening, it may also be put on afterwards, i.e., after casting of the muffle, but before the investment material has cured.

The investment material cures in a way known per se. After curing, the muffle bottom is removed together with the muffle mandrel. The muffle bottom consists of an elastic mass such as silicone. The removal process causes the connection to the sprue channels and/or the sprue channel base provided thereat to break.

Furthermore, the muffle ring and muffle lid are also removed which also consist of a material which may be detached from the now hardened investment material in a way known per se.

The cured investment material which comprises the molded part or moldings and the dental restoration parts made of wax is now heated, e.g. in a preheating furnace or a waterbath such that all wax parts melt out and flow out via the openings open to the outside.

In the first embodiment, cavities are now present at the positions at which the molded part or moldings and dental restoration parts prefabricated from wax were provided.

In the second embodiment, boundaries between the molded part or molding and the casting compound are created, respectively. As the materials are dispersed no material transition region is created even if heated. The boundary which is hard in this respect offers no connection of the materials beyond the boundary. There is no cohesion. In this way, a predetermined breaking point each is provided thereat.

In the state in which the investment material is present currently, it is turned upside down such that the muffle bottom side is at the top. The position that was originally occupied by the muffle mandrel is now a hollow cylinder and freely accessible from the top.

A matching blank consisting of dental restoration material is inserted therein. The filling opening is closed by an Al₂O₃ piston, and the muffle, that is to say, the investment material with the cavities is now inserted into a preheating furnace and then into a press furnace.

In the preheating furnace it is heated to a range of from about 700 to 900° C., and it is further heated in the press furnace. The blank may consist of e.g. lithium disilicate. This material is still solid at the preheating temperature.

Now, in a way known per se, the press plunger of the press furnace exerts pressure onto the Al₂O₃ piston and thus onto the blank which may now be referred to as pressed blank.

The pressed blank is further heated by the heating of the press furnace, and once it is flowable, the blank material flows into the mold cavities in which the dental restoration parts are to be configured via the sprue channels.

After the press cycle is finished, the press plunger of the press furnace is withdrawn and the muffle is removed from the press furnace and cools in the ambient air.

As the muffle is relatively hot initially, e.g. 900° C., cooling takes place relatively quickly initially.

At the positions at which the molded part or moldings are realized cavities or gaps have remained in the first embodiment, and the molded part or moldings or protrusions with their separable boundaries in the second embodiment.

Once the initial cooling process has been carried out and cooling has become slower, a heat-resistant cutting tool is now used. In this way, the upper and lower parts of the investment material are split off from the central part. The central part remains which comprises about half the height of the entire muffle and contains the dental restoration parts. This central part may also be referred to as the muffle core.

Instead of using a cutting tool, pressurized air may also be introduced without further ado. The weak spots formed by the molded part or moldings are utilized in this way, and the muffle breaks leaving the muffle core.

Moreover, the supplied pressurized air has an additional cooling function.

It is also possible to use the pressurized air for cooling purposes at the predetermined breaking points before separation, as it is possible to even cool deep regions of the muffle due to the slits exposed to the outside.

After the muffle core has also cooled slightly, e.g. to 250° C., it is sandblasted in a way known per se. As no longer the entire muffle but only slightly less than half of the investment material needs to be removed at the muffle core, sand consumption and the time spent on divestment are considerably lower here.

Waterjet cutting is also possible instead of sandblasting.

Surprisingly, the strength of the muffle, i.e. of the cured investment material, against the press force is not reduced or not reduced significantly even in the first embodiment. This is due to the apertures of the molded part or moldings which allow for a strong material connection e.g. between the muffle core and the upper and lower parts of the muffle.

The molded part or moldings or protrusions produced by the molded part or moldings or protrusions in the muffle or the indentations or mold cavities may be configured in any desired suitable manner.

The main idea is to weaken the muffle structure with regard to the aspect of “separation”, that is to say to allow for division of the muffle into several individual parts. However, it is important likewise that the mold cavities or indentations do not weaken the stability of the muffle in the radial direction—when viewed from the dental restoration parts—also in case of the first embodiment.

The muffle must and should keep its shape just like a muffle which is provided without corresponding mold cavities in the classical manner according to the state of the art.

The focus of the arrangement of the molded part or moldings and mold cavities is preferably a region between the bottom of the muffle, that it to say the side to which the muffle bottom is attached, and the region of the dental restoration parts. There, a first predetermined breaking point is provided preferably closer to the dental restoration parts than to the muffle bottom. A further predetermined breaking point is preferably provided between the plane of the dental restoration parts and the upper side of the muffle.

It is preferred that at least one dental restoration part or a plurality of dental restoration parts is arranged remote from a lower end of the muffle and also from an upper end of the muffle when viewed along the height of the muffle, and that at least one molded part or molding or protrusion each is configured above and below the one or more dental restoration parts, in terms of the height of the muffle.

The molded part or moldings and possibly the mold cavities are preferably formed by a disc with apertures wherein it is to be understood that such a substantially planar shape is not mandatory.

Alternatively, the disc which configures the molded part or molding or the protrusion may extend in a three-dimensional structure, i.e. curved, through the muffle.

The apertures of the disc or the other molded part or molding enable stiffening of the muffle against the press force on the one hand, and easy inflow of the casting compound into the region below the disc on the other hand.

Instead of a planar or straight disc it is also possible for instance to realize a paraboloid-configured disc whose focal point may then be arranged adjacent to the dental restoration parts.

It is advantageous when the discs and/or the molded part or moldings or protrusions comprising the discs are mounted in a supported manner with respect to their height either on the muffle mold or a muffle lid in particular before casting to provide the muffle by means of a casting compound.

Further, it is provided in an advantageous configuration that the upper molded part or molding is configured above and the lower molded part or molding below the plane of the dental restoration parts.

In an advantageous configuration of the invention it is provided that outer regions of the molded part or moldings cause a lower strength of the muffle at this position, and thus a greater likelihood of breaking. For instance, the edge of the molded part or molding may completely discontinue the lateral surface of the muffle.

By contrast, it is preferred that a certain amount of investment material is provided continuously around the press channel to reliably absorb the pressure existing in the press channel.

The regions provided between the apertures form webs which safely transfer the press force reliably to the outside.

The inventive molded part or moldings may be produced in any desired manner specific to the muffle. They may be produced e.g. by injection molding a molded part or molding or by using a 3D printer. It is also possible to provide the molded parts adapted to the dental restoration parts to be produced, after the shape of these parts has also been digitally available.

The material which may be burnt out and that which is to be used for the molded part or moldings may be the same material as that burn-out material used for the dental restoration parts. However, it is also possible to use a lower priced material as the shape accuracy of the molded part or moldings is less relevant than that of the dental restoration parts.

### BRIEF DESCRIPTION OF THE DRAWINGS

Further advantages, details and features may be taken from the following description of several exemplary embodiments of the invention in conjunction with the drawings, in which:

FIG. 1 shows a perspective illustration of an inventive dental muffle for use in an inventive dental divestment method in a first embodiment;

FIG. 1a shows a top view of a possible embodiment of a molded part or molding for use with the dental divestment method according to the invention;

FIG. 1b shows a further embodiment of a molded part or molding for use with the inventive divestment method;

FIG. 2 shows a schematic illustration of an inventive dental muffle in a side view in a further embodiment;

FIG. 3 shows a schematic illustration of an inventive dental muffle in a side view in a further embodiment;

FIG. 4 shows a schematic illustration of an inventive dental muffle in a side view in a further embodiment;

FIG. 5 shows a schematic illustration of an inventive dental muffle in a side view in a further embodiment;

FIG. 6 shows a schematic illustration of an inventive dental muffle in a side view in a further embodiment;

FIG. 7 shows a schematic illustration of an inventive dental muffle in a side view in a further embodiment;

FIG. 8 shows a schematic illustration of a part of the dental muffle in the second embodiment; and

FIG. 9 shows a schematic illustration of the same part of the muffle but in the first embodiment.

### DETAILED DESCRIPTION

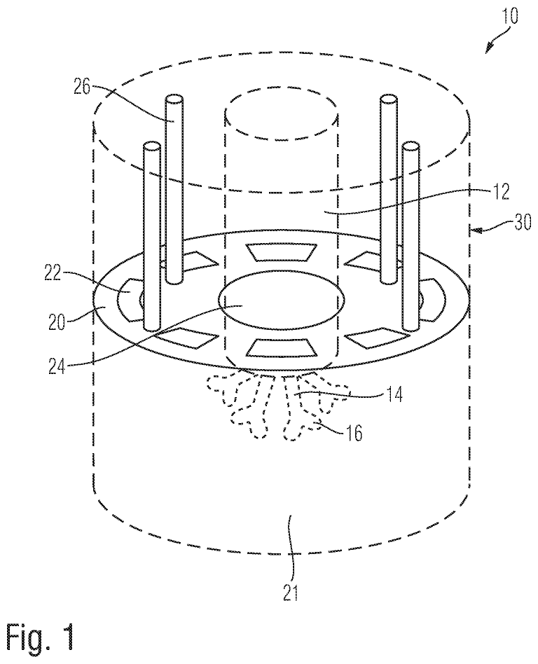

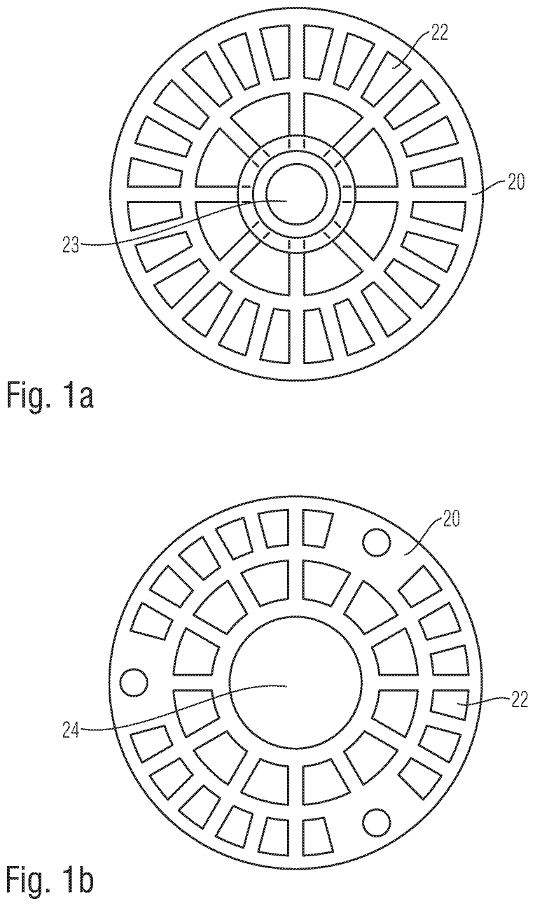

A dental muffle 10 is illustrated in dashed lines in FIG. 1. In FIG. 1 the muffle 10 is illustrated in the press position in which its actual bottom side is at the top. In the initial position, that is to say in the casting position, the muffle 10 is upside down as opposed to the illustration according to FIG. 1.

In a way known per se, a press channel 12 illustrated in dashed lines is provided which is connected with mold cavities or molded parts or moldings for dental restoration parts 16 via sprue channels 14.

The dental restoration parts 16 extend annularly radially outside of the press channel 12, in the position of the muffle 10 according to FIG. 1 obliquely below the press channel 12.

According to the invention, a molded part or molding 20 is provided which is inserted into the muffle 10 before the investment material or casting compound 21 solidifies. In the exemplary embodiment illustrated, the molded part or molding 20 is substantially disc-shaped wherein it comprises a plurality of apertures 22 in any case.

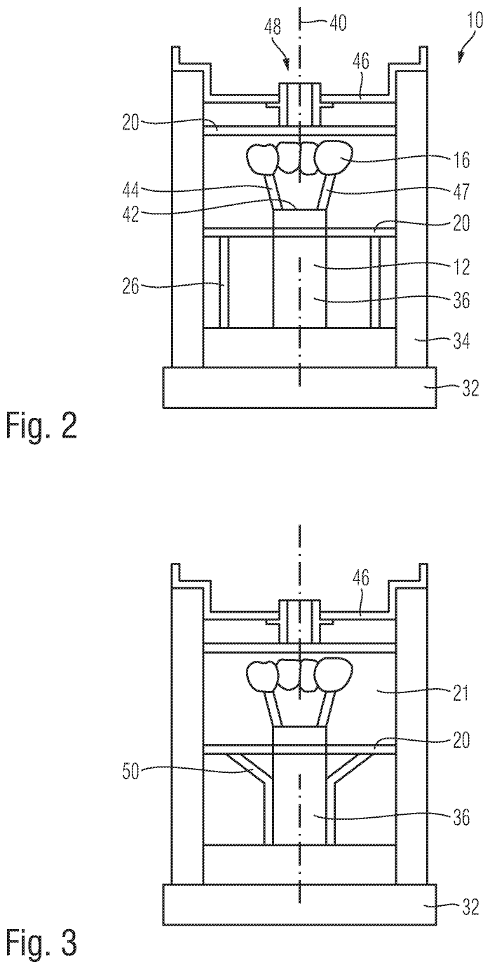

The apertures 22 extend radially outside of a mandrel aperture 24. The aperture serves to receive the muffle mandrel 36 (see e.g. FIG. 2) and is sized such that it is spaced apart considerably from the muffle mandrel 36.

In this respect, the molded part or molding 20 is like a circular ring-shaped disc with apertures 22.

The molded part or molding 20 extends substantially at half the height of the muffle 10.

The positioning of height is realized in the illustrated exemplary embodiment by feet 26 which are supported on a muffle bottom 32 illustrated in FIG. 3.

The length of the feet 26 is selected such that the circular disc 20 is located just below (in the illustration according to FIG. 1 just above) the dental restoration parts 16.

The molded part or molding 20 extends out to the lateral surface 30 of the muffle 10.

After the muffle 10 has cured, the muffle 10 is burnt out, that is to say that all enclosed regions made of wax are melted out and removed. Accordingly, this also holds true for the molded part or molding 20. As a result of this configuration, a slit 62 whose thickness corresponds to the thickness of the molded part or molding 20 extends in the lateral surface 30 of the cured muffle 10. This spot serves as a predetermined breaking point for parting the muffle 10.

The slit 62 is circular and circumferential, however it does not lead to the muffle 10 being separated in two parts. Rather, it is still made of one piece as the investment material 21 of the muffle 10 also extends through the apertures 22.

In this respect, the apertures 22 have the dual function of enabling inflow into the lower part of the muffle 10 during casting of the casting compound 21 on the one hand, and of allowing for cohesion of the muffle 10 after the casting process.

From FIG. 1a, an exemplary embodiment of a molded part or molding 20 of this kind is apparent in the top view. A plurality of apertures 22 is provided. This also includes a central aperture 23.

The molded part or molding 20 according to FIG. 1a is intended for being deposited or inserted above the dental restoration parts 16. At this position, the press channel 12 and the associated muffle mandrel 36 do not exist anymore such that the central aperture 23 may be smaller than the muffle mandrel.

From FIG. 1b, a molded part or molding 20 is apparent which may be arranged at the position according to FIG. 1. Here, too, a plurality of apertures 22 are provided wherein a mandrel aperture 24 has a diameter which is considerably larger than the muffle mandrel 36.

An embodiment of an inventive dental muffle 10 during the investment process is apparent from FIG. 2. A molded part or molding 20 extends in the region of the press channel 12, i.e. below the dental restoration parts 16. A further molded part or molding 20 extends above the dental restoration parts 16 and may be configured according to FIG. 1a for instance.

The muffle 10 rests on a muffle bottom 32. It is connected in a liquid-tight manner with a muffle ring 34. A muffle mandrel 36 extends from the muffle bottom 32 towards the top. Muffle mandrel 36 and muffle bottom 32 are integral with one another in a way known per se and consist of e.g. silicone.

From the muffle bottom 32 the muffle mandrel 36 protrudes centrally to the top along the axis 40 of the muffle 10 and extends approximately up to half the height of the muffle 10 or slightly beyond. A sprue base may be waxed on its upper side 42 in a way known per se. Alternatively, sprue channels 44 and 47 extend from the muffle mandrel 36 obliquely radially towards the outside and the top. On the other end of the sprue channels 44 and 47, dental restoration parts 16 are arranged, or else initially corresponding wax molded parts to form the dental restoration parts 16.

To produce the cast muffle 10, the muffle bottom 32 is initially positioned and provided with the muffle ring 34. The arrangement of dental restoration parts 16 or else their wax models is located on the muffle mandrel 36.

The molded part or molding 20 is now pulled over the dental restoration parts 16 and placed on the feet 26 such that it extends in a disc-shaped manner slightly below the dental restoration parts 16.

For this purpose, it is required that the mandrel aperture 24 apparent from FIG. 2b has a sufficient size to fit outside of the dental restoration parts 16.

Alternatively, the molded part or molding 20 may also be placed on the muffle bottom 32 before the dental restoration parts 16 are waxed thereon.

The muffle 10 illustrated herein comprises a muffle lid 46 which fits on the muffle ring 34. The muffle lid 46 comprises a filling opening 48 via which it is possible to fill the interior of the muffle ring 34 with the liquid investment material 21.

There, a second molded part or molding 20 which is also disc-shaped is also mounted in a suspended manner. This upper molded part or molding 20 terminates slightly above the dental restoration parts 16.

Alternatively, it is also possible that the upper molded part or molding 20 is supported with additional feet 26 on the molded part or molding 20 below the dental restoration parts 16.

When the muffle lid 46 comprises no filling opening 48, it is still possible to provide the upper molded part or molding 20 in a suspended manner. In that case, the muffle 10 is filled and the lid with the suspended molded part or molding 20 is placed thereupon, while the investment material 21 is still liquid.

In any case, the upper molded part or molding 20 also comprises apertures 22 and for instance corresponds to the configuration according to FIG. 1a.

Further possible modifications of the inventive molded part or moldings 20, i.e. of the upper molded part or molding 20 and the lower molded part or molding 20, are apparent from FIGS. 3 to 7.

FIG. 3 shows a support arrangement 50 for the lower molded part or molding 20 instead of the feet 26, said support arrangement 50 leaning centrally against the muffle mandrel 36 and extending therefrom laterally radially towards the outside and obliquely towards the top to determine the position of height of the lower molded part or molding 20.

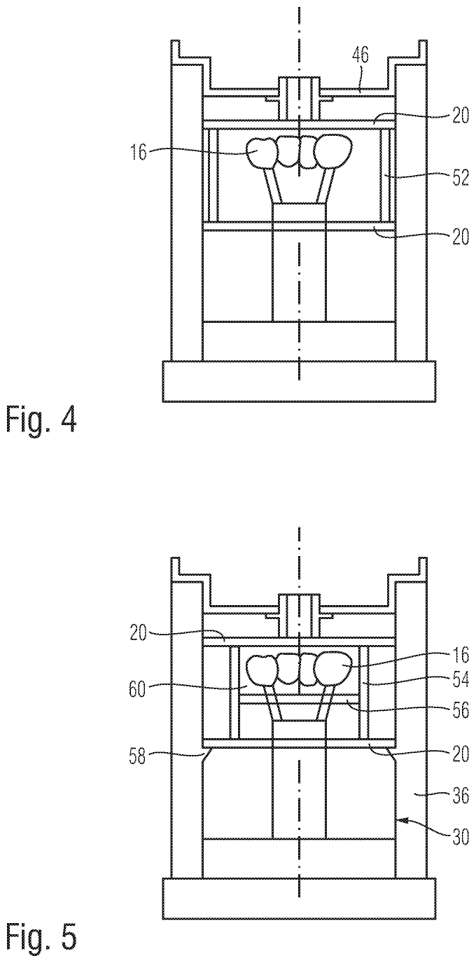

FIG. 4 shows a configuration in which the muffle lid 46 carries both the upper molded part or molding 20 and the lower molded part or molding 20. For this purpose, cross members 52 which fix the distance between the lower and the upper molded part or molding are provided instead of feet 26.

In this configuration, the central mandrel aperture 24 should be so large in any case that it may be pulled over the arrangement of the dental restoration parts 16.

FIG. 5 shows an arrangement of additional molded parts or moldings 54 and 56. The molded part or molding 54 extends like a circular wall radially within the muffle ring 36. It comprises numerous apertures.

The molded part or molding 56 extends radially within the molded part or molding 54 and between the dental restoration parts 16 and the lower molded part or molding 20.

In the embodiment illustrated herein, the lower molded part or molding 20 is additionally supported on protrusions 58. The protrusions 58 extend radially towards the inside at the muffle ring 36.

While in case of the embodiments of the muffle 10 according to FIGS. 2 to 4 the muffle 10 is initially parted along the lower molded part or molding 20 and then along the upper molded part or molding 20 which each form predetermined breaking points after burning out, a further separation is possible in the embodiment according to FIG. 5.

Here, too, the predetermined breaking points along the molded part or moldings 20 and 54 are initially utilized again. However, the remaining central part of the muffle 10 may be separated further by also splitting off radial outer parts of the muffle 10 along the slits 62 or predetermined breaking points corresponding to part 54.

There, too, ribs may extend between the molded part or molding 54 and the muffle ring 36 radially towards the outside such that the corresponding parts may be separated more easily in the manner of pieces of a cake.

Additionally, further separation of the now remaining muffle core may be performed along the predetermined breaking point corresponding to the molded part or molding 56. Thus, only one muffle core piece 60 remains which is markedly compact and extends only slightly outside of the dental restoration parts 16.

As all the molded part or moldings comprise apertures 22 respectively, the pressure existing thereat is still supported by the muffle material up to the lateral surface 30 of the muffle 10 such that muffle breakages or muffle cracks must not be feared.

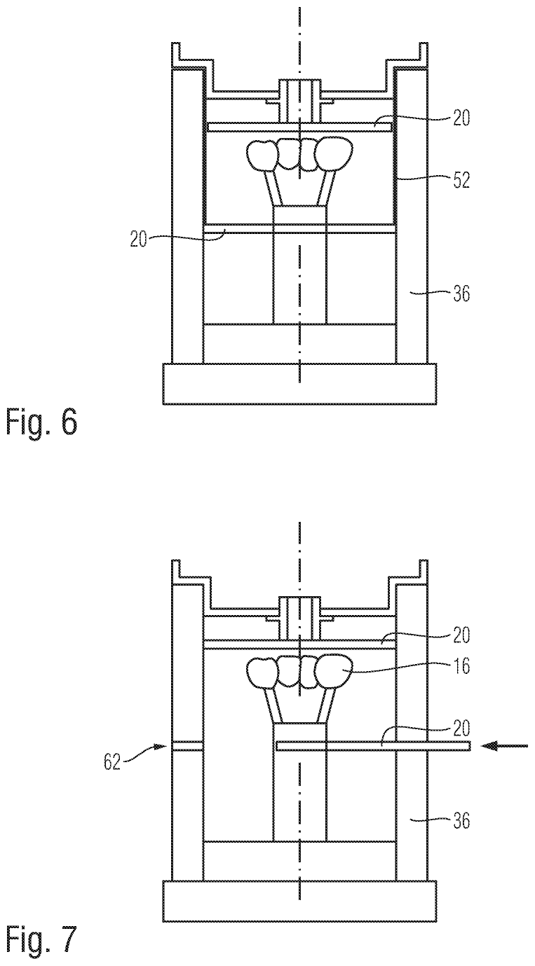

In the embodiment according to FIG. 6, the lower molded part or molding 20 is supported by hanging struts 52 at the upper edge of the muffle ring 36.

In the embodiment according to FIG. 7, the upper molded part or molding 20 is realized in the manner as already mentioned, while the lower molded part or molding 20 is slid in through a slit 62 in the muffle ring 36 laterally at the desired height. It is to be understood that in this solution the mandrel aperture 24 is open laterally in a U-shaped manner. If desired, this embodiment allows for a comparatively small mandrel recess as the lower molded part or molding 20 is slid in when the dental restoration parts 16 are already in situ.

The molded part or molding 20 is supported in the slit 62 in the ring 36 wherein it is to be understood that sealing measures may be taken against leaking investment material 21 if necessary.

The dental divestment method, referred to as second embodiment further above in the description, is to be described below.

In contrast to the configuration according to claim 1 which is referred to as the “first embodiment” herein, the material of the molded part or moldings 20 or protrusions 58 may not be removed by boiling out or burning out in this configuration. When the wax-like material in the mold cavities for the dental restoration parts 16 is removed, the material of the molded part or moldings remains in the muffle 10.

The configuration of the molded part or moldings 20 or protrusions 58 may correspond to the configuration according to FIGS. 1 to 7 and may thus be provided in any desired manner to provide for the desired predetermined breaking point 70.

Technical basis for realizing the predetermined breaking point 70 by means of the non-removable molded part or moldings is the boundary layer or boundary 66 and 68 thereof towards the casting compound 21 of the muffle.

The molded part or moldings 20 of this second embodiment are also invested in the casting compound 21. The phosphatic casting compound 21 tends to penetrate into porous or rough surfaces and to produce a secure connection.

This tendency is counteracted inventively in that the molded part or moldings 20 or protrusions 58 are smooth and thus have a very low surface roughness of less than Rₐ=2 μm.

Additionally, the materials of the molded part or moldings 20 on the one hand and of the casting compound 21 on the other hand are dispersed against each other, i.e. they do not mix with one another even when heat-treated.

The microgap existing at the boundary 66 and 68 in this respect is sufficient to form the desired predetermined breaking point 70. If a breaking force is applied thereto, the muffle 10 splits up at the boundary 66 and 68 from the molded part or molding 20. This may be realized e.g. by a breaking process but also by means of a cutting tool such as a chisel which is applied on the outside at the boundary 66 and 68.

It is to be understood that a disc-shaped molded part or molding 20 has two boundaries 66 and 68, or possibly additional boundaries 66 and 68 of which one points upwards and the other points downwards. Both boundaries 66 and 68 may be provided as predetermined breaking points 70, wherein it is sufficient basically to keep one of the boundaries 66 and 68 smooth and to realize it as a predetermined breaking point 70 accordingly.

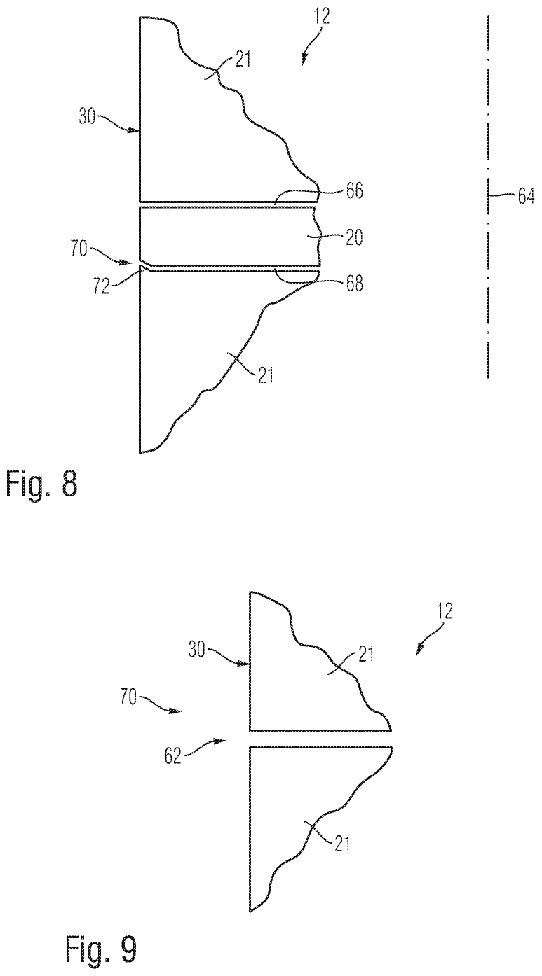

A possible configuration of a part of a corresponding muffle 10 according to this second embodiment is illustrated in FIG. 8. The molded part or molding 20 extends in a disc-shaped manner of which a radial outer region is illustrated. Apertures 22 are provided radially further to the inside but are not illustrated herein.

In the embodiment according to FIG. 8, i.e. the embodiment referred to as second embodiment, the molded part or molding 20 is comparatively thick. It may be fabricated of materials such as, but not limited to, certain silicates, zirconia, alumina, ceramics, glass-ceramics and the like, which have a considerably higher thermal capacity than the phosphate-bonded investment material and which are preferably not removable during the burn-out process.

This fact may be utilized specially according to the invention:

During the first cooling process of the hot muffle 10, the muffle 10 initially becomes comparatively cold at the lateral surface 30 of the muffle 10, and then cools both the casting compound 21 and the molded part or molding 20. While doing so, however, the casting compound 21 cools more quickly than the molded part or molding 20, due to its lower thermal capacity. It is assumed, for instance, that the casting compound 21 has a temperature which has dropped to 600° C., while the molded part or molding 20 further radially towards the inside still has a temperature of 900° C.

In this state, the volume of the molded part or molding 20 is larger compared to that of the molded part or molding compound than when the parts have the same temperature. Thus, axial pressure is exerted along the cylinder axis 64 of sleeve 10 at the location of molded part or molding 20, as it were, from the inside. The casting compound 21 is brittle and therefore breaks at the location of the molded part or molding 20.

However, it is also possible to work with comparatively thin molded part or moldings 20 made of a heat-resistant material, and to still realize a predetermined breaking point 70. In this embodiment, the thickness may correspond to that of the slit 62 from FIG. 9, for instance.

In this instance, the axial force is not sufficient for splitting the muffle 10 due to the greater expansion of the molded part or molding 20, since the temperatures are angled across the interfaces 66 and 68 due to the heat conduction of the molded part or molding 20.

In this embodiment, the smoothness of the molded part or molding 20 at the boundaries 66 and 68 towards the muffle material 21 is effective. There is a microgap thereat which does not offer any cohesion against axial forces.

This may be utilized by applying a cutting tool for instance at the predetermined breaking point 70 corresponding to the radial outer end of the boundary 68 and thus splitting the muffle 10 at this position.

It is also possible to round the molded part or molding 20 thereat, i.e. for instance at the lower boundary 68, in a slightly convex manner. Then, the casting compound 21 forms a circumferential tongue-like protrusion 72 towards the top which can be easily removed with a knife or screwdriver, for example, in order to be able to attach the cutting tool more easily.

It is to be understood that here both boundaries 66 and 68 are available as predetermined breaking points 70. If a bending force is applied to the muffle 10 without further ado, the muffle 10 will break at the position at which the casting compound 21 which extends through the apertures 22 not illustrated comprises the lower cohesion.

Compared to the embodiment referred to as second embodiment herein, the realization of a predetermined breaking point 70 in the embodiment referred to as first embodiment herein is illustrated in FIG. 9. The slit 62 was produced by a removed molded part or molding 20.

The predetermined breaking point 70 is clearly visible as slit 62. Here, a cutting tool may be applied, or a bending force or a torsional moment is exerted on the muffle 10 to break the casting compound 21 extending through the apertures 22 at this position which ensures for cohesion.

1. A dental divestment method for divestment of one or more dental restoration parts comprising
divesting the one or more dental restoration parts from a cured muffle by parting or blasting,
wherein, in the production of the muffle (10), before the muffle is cast by a casting compound (21), one or more molded parts (20) or protrusions (58) are realized in or at a casting mold wherein the one or more molded parts (20) or protrusions (58) are fabricated of a removable material,
wherein the one or more molded parts (20) or protrusions (58) are removed after the muffle (10) has cured, and
wherein indentations or mold cavities produced from the one or more molded parts or protrusions are configured and/or used as one or more predetermined breaking points for the muffle (10) during divestment.

2. The dental divestment method as claimed in claim 1,
wherein the one or more dental restoration part is removed by sandblasting,
wherein the removable material is a burn-out material, and
wherein the one or more molded parts (20) or protrusions (58) are removed by a burn-out process.

3. A dental divestment method for divestment of one or more dental restoration parts comprising
divesting the one or more dental restoration parts from a cured muffle by parting or blasting,
wherein, in the production of the muffle (10), before the muffle is cast by a casting compound (21), one or more molded parts (20) or protrusions (58) are realized in or at the casting mold, wherein one or more molded parts (20) or protrusions (58) are fabricated of a material which differs from the casting compound (21), and
wherein the one or more molded parts (20) or protrusions (58) are configured and/or used as one or more predetermined breaking points for the muffle (10) during divestment.

4. The dental divestment method as claimed in claim 3,
wherein the one or more dental restoration parts is removed by sandblasting,
wherein the one or more molded parts (20) or protrusions (58) is not removed by a burn-out process.

5. The dental divestment method as claimed in claim 1,
wherein a mark is configured at the muffle by the one or more molded parts (20), said mark extending radially outside the one or more dental restoration parts (16) and at a point outside of which the muffle material is removed quickly by rough blasting.

6. The dental divestment method as claimed in claim 1,
wherein the muffle (10) is broken into at least two parts using the one or more predetermined breaking points after the muffle is cooled to a processing temperature and only the muffle core (60) of the muffle (10) comprising the one or more dental restoration parts (16) is blasted.

7. The dental divestment method as claimed in claim 1,
wherein a plurality of rib-shaped radial apertures (22) extend from an imaginary ring surface outside of the one or more dental restoration parts (16) to the outside,
wherein both the ring surface and the cavities or the boundaries between the one or more molded parts (20) and the casting compound (21) are configured as one or more predetermined breaking points, and
wherein pieces surrounding the apertures extending radially are removed after the muffle (10) is cured.

8. The dental divestment method as claimed in claim 1,
wherein a heat-resistant cutting tool is used with which the muffle (10) is cut in a hot state along one or more indentations which act as the one or more predetermined breaking points, and
wherein a part of the muffle (10) comprising the one or more dental restoration parts (16) is further cooled and/or blasted.

9. The dental divestment method as claimed in claim 8,
wherein the heat-resistant cutting tool comprises a sandblaster.

10. The dental divestment method as claimed in claim 1,
wherein a fastening device and/or support struts are mounted to a muffle mold, a muffle bottom or a muffle lid (46) non-positively, positively or frictionally before the casting compound (21) is cast.

11. The dental divestment method as claimed in claim 1,
wherein the one or more molded parts (20) is produced in a prefabricated manner by injection molding or by 3D printing, and
wherein the one or more dental restoration parts (16) and the one or more molded parts are produced to match one another.

12. A dental muffle comprising
a dental restoration part invested in a casting compound (21),
wherein the casting compound comprises one or more predetermined breaking points spaced apart from the dental restoration part (16),
wherein the one or more predetermined breaking points are formed by (i) one or more molded parts or protrusions fabricated of a material which is different from the casting compound (21) and not removable by a burn-out process, or (ii) indentations or mold cavities which are configured from one or more molded parts or protrusions which are removable by the burn-out process.

13. The muffle as claimed in claim 12,
wherein the muffle (10) is cylindrical and
wherein the one or more predetermined breaking points is/are arranged outside a height of the invested dental restoration part (16) when viewed along a cylinder axis of the muffle.

14. The muffle as claimed in claim 12,
wherein the one or more molded parts (20) or protrusions (58) preparing a predetermined breaking point is part of a horizontal molded part (20) having apertures (22),
wherein the one or more molded parts (20) extend transversely through the muffle (10).

15. The muffle as claimed in claim 12,
wherein the one or more molded parts comprise a disc,
which the disc or protrusion (58) extends substantially planar, in a direction of the diameter of the muffle (10), through the muffle.

16. The muffle as claimed in claim 12,
wherein support struts are anchored to the one or more molded parts (20) or extend away from the one or more molded parts (20) in one piece,
wherein the support struts are mounted on a muffle bottom.

17. The muffle as claimed in claim 15,
wherein the apertures of the disc occupy at least 10% and no greater than 90% of the disc or between 20% and 80% of the disc or between 30% and 70% of the disc.

18. The muffle as claimed in claim 12,
wherein at least one fastening element for one or more molded parts (20) is configured in one piece with the one or more molded parts (20),
wherein the at least one fastening element supports the one or more molded parts on a muffle mold or a muffle lid (46).

19. A method for producing dental articles comprising
shaping a model of a desired dental article using a removable material,
inserting the model into a muffle,
inserting one or more molded parts or protrusions, fabricated of a removable material, in the muffle above and/or below the model,
inserting casting material into the muffle and curing the casting material,
removing the removable material,
wherein molds for the desired dental article are produced from the model,
wherein indentations or cavities are produced from the one or more molded parts or protrusions,
wherein the indentations or mold cavities produced are configured and/or used as one or more predetermined breaking points for the muffle during divestment.

20. A method for producing dental articles comprising
shaping a model of a desired dental article using a removable material,
inserting the model into a muffle,
inserting one or more molded parts or protrusions, fabricated of a heat-resistant material, in the muffle above and/or below the model,
inserting casting material into the muffle and curing the casting material,
removing the removable material,
wherein molds for the desired dental article are produced from the model,
wherein the one or more molded parts or protrusions are configured and/or used as one or more predetermined breaking points for the muffle during divestment.
